(19) United States
(12) Patent Application Publication
(10) Pub. No.: US 2013/0226698 A1
(43) Pub. Date: Aug. 29, 2013

(54) SYSTEM, METHOD AND PROGRAM FOR EMBEDDING IN LINE ADVERTISEMENTS DURING A MULTI-FACTOR AUTHENTICATION SESSION

(71) Applicants: Munir Cochinwala, Basking Ridge, NJ (US); Richard J. Lipton, Atlanta, GA (US); Shoshana K. Loeb, Philadelphia, PA (US)

(72) Inventors: Munir Cochinwala, Basking Ridge, NJ (US); Richard J. Lipton, Atlanta, GA (US); Shoshana K. Loeb, Philadelphia, PA (US)

(73) Assignee: TELCORDIA TECHNOLOGIES, INC., Piscataway, NJ (US)

(21) Appl. No.: 13/405,425

(22) Filed: Feb. 27, 2012

(51) Int. Cl. G06Q 30/02

(52) U.S. Cl. 705/14.53

(57) ABSTRACT

Systems, methods and programs for determining a question posed to a user during a user authentication process are provided. An example of a method for determining the question comprises obtaining user commercial activity, storing the user commercial activity by activity type, generating a set of candidate questions for a user based upon the user commercial activity, each candidate question in the set of candidate questions is associated with a score, selecting one candidate question from the set of the candidate questions based upon a first selection criteria, detecting a vendor placement opportunity in the selected candidate question by analyzing the user commercial activity and adding a vendor name into the selected candidate question based upon the detecting. The user commercial activity can be user purchases of goods and services from corresponding vendors. Lost Opportunities for the placement of an advertisement are detected and recorded.

### FIELD OF THE INVENTION

This invention relates to user authentication using personal information and available commercial use information. More particularly, this invention relates to embedding or adding advertisements based upon a registered user's commercial use information into a question posed to a user during a multi-factor authentication session.

### BACKGROUND

Multi-factor authentication sessions are used to authenticate a user. Many institutions such as banks, brokerage houses, doctor offices and other information sensitive institutions implement a multi-factor authentication session to authenticate a user. A multi-factor authentication session uses shared “secret” information related to a registered user to authenticate the user and ultimately grant access to only a registered user. The user is asked a series of questions that only the user knows the answers to. One type of question uses publically available knowledge where there is a high probability that only the user would know the answer. For example, a question can be derived from registered user's recent purchases of goods and services. The question is typically posed to a user using a question template.

Each question is assigned a probability or a score. The questions are selected to maximize the score using a minimal number of questions. Each time a user answers a question correctly, the value of the score is added to a previous total score. Access is granted, e.g., the user is authenticated, only if the user correctly answers questions where the total score exceeds a predetermined threshold without exceeding a preset number of questions, i.e., the user is the registered user.

### SUMMARY OF THE INVENTION

Disclosed is a system and method that uses the available user commercial activity to add or embed in-line advertisements into the questions posed to a user during the multi-factor authentication session. By adding the advertisements into the questions, the advertiser has the opportunity to have a targeted advertisement. The system tracks the number of placements of a targeted advertisement and the advertiser is charged an agreed upon rate for the placement.

method for determining a question posed to a user during a user authentication process comprises obtaining user commercial activity, the user commercial activity being user purchases of goods and services from corresponding vendors, storing the user commercial activity by activity type, detecting a vendor placement opportunity by analyzing the user commercial activity, determining if a vendor is registered for placement into a question based upon the detecting, selecting a question based at least upon the detecting and determining for inclusion in a user authentication process; and adding a vendor name into the selected question based upon a preset addition criterion.

Also disclosed is a method for determining a question posed to a user during a user authentication process comprising obtaining user commercial activity, the user commercial activity being user purchases of goods and services from corresponding vendors, storing the user commercial activity by activity type, generating a set of candidate questions for a user based upon the user commercial activity, each candidate question in the set of candidate questions is associated with a score, selecting one candidate question from the set of the candidate questions based upon a first selection criteria, detecting a vendor placement opportunity in the selected candidate question by analyzing the user commercial activity and adding a vendor name into the selected candidate question based upon the detecting.

Also disclosed is a corresponding computer readable storage device having a program for perform the above methods.

For example, disclosed is a computer readable storage medium having a computer program for causing a processor to execute a method for determining a question posed to a user during a user authentication process, the method comprises obtaining user commercial activity, the user commercial activity being user purchases of goods and services from corresponding vendors, respectively, storing the user commercial activity by activity type, generating a set of candidate questions for a user based upon the user commercial activity, each candidate question in the set of candidate questions is associated with a score, selecting one candidate question from the set of the candidate questions based upon a first selection criteria, detecting a vendor placement opportunity in the selected candidate question by analyzing the user commercial activity and adding a vendor name into the selected candidate question based upon the detecting.

Also disclosed is a system for determining a question posed to a user during a user authentication process comprising a storage device having processor readable instructions and a processor configured to, when executing the processor readable instructions, provide an obtaining unit for obtaining user commercial activity, the user commercial activity being user purchases of goods and services from corresponding vendors, respectively, a question generating unit for generating a set of candidate questions for a user based upon the user commercial activity, each candidate question in the set of candidate questions is associated with a score, a selecting unit for selecting at least one candidate question from the set of candidate questions based at least upon the score, a detecting unit for a vendor placement opportunity in the selected at least one candidate question by analyzing the user commercial activity and corresponding available advertisers and a question unit for adding a vendor name into a candidate question based upon the detecting.

### BRIEF DESCRIPTION OF THE DRAWINGS

These and other features, benefits, and advantages of the present invention will become apparent by reference to the following figures, with like reference numbers referring to like structures across the views, wherein:

FIG. 1 illustrates a block diagram of an exemplary multi-factor authentication system according to the invention;

FIG. 2 illustrates a flow chart for an exemplary method for registering a user and generating question candidates in accordance with the invention;

FIG. 3 illustrates a flow chart for an exemplary method for obtaining participating vendors and advertisers in accordance with the invention;

FIG. 4 illustrates a flow chart for an exemplary method for authenticating a register user in accordance with the invention;

FIG. 5 illustrates a flow chart for an exemplary method for determining a missed advertisement opportunity in accordance with the invention; and

FIG. 6 illustrates a flow chart for an exemplary method for generating an invoice for an advertiser in accordance with the invention.

### DETAILED DESCRIPTION OF THE INVENTION

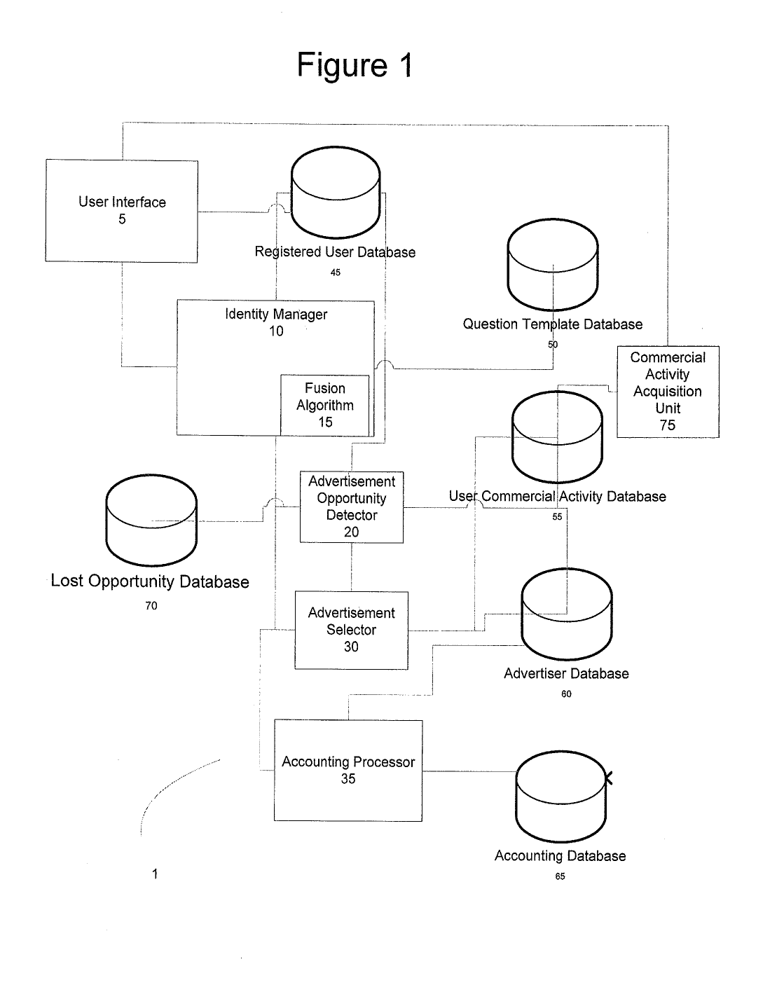

FIG. 1 illustrates a high level block diagram of an exemplary multi-factor authentication system 1 (“the authentication system”). The authentication system 1 both authenticates a register user and provides a vendor/advertiser an opportunity for a targeted advertisement to the register user by matching an appropriate advertisement to a user's commercial activity. An advertiser registers, in advance, with the authentication system 1. The registration includes agreeing to pay for the placement of the targeted advertisement.

Specifically, the vendors that the user purchased goods and services will pay for the opportunity to be mentioned to the user during the authentication process. For example, ABC Airlines may be willing to pay for the opportunity to be mentioned in a question like “where did you fly last on ABC airlines?” Questions are presented to the user based upon an analysis of the user's commercial activity, available advertisers for the activity and the agreed upon payment rate in addition to a score or probability associated with a candidate question.

The authentication system 1 includes at least one User Interface 5, an Identity Manager 10, an Advertisement Opportunity Detector 20, an Advertisement Selector 30, an Accounting Processor 35 and a Commercial Activity Acquisition Unit 75. Additionally, the authentication system 1 includes several databases including a Registered User Database 45, a Question Template Database 50, a User Commercial Activity Database 55, an Advertiser Database 60, an Accounting Database 65 and a Lost Opportunity Database 70.

The Identity Manager 10 coordinates the identity verification process by selecting and posing identification questions to end users in conjunction with the advertisement selector 30 and collecting and verifying responses from them. The exact set of questions posed to users varies from session to session and is decided by the Identity Manager 10. The Identity Manager 10 includes a Fusion Algorithm 15 which is executed to verify user responses to identification questions. The Identity Manager 10 can be a processor programmed with instructions to execute the functionality described herein. As such, the Identity Manager 10 includes a storage device (not shown). The storage device contains a program. Additionally, the storage device contains the Fusion Algorithm 15.

User Interface 5 presents the front end through which end users register and interact with the system 1. The User Interface 5 can be, but is not limited to a voice interface, a data interface and a biometric interface. The voice interface can be a voice input section of a mobile communication device, such as a cellular telephone, PDA, or a smartphone. Additionally, the voice interface can be a microphone peripheral attached to a desktop computer or a laptop. The voice interface can be used to answer the questions posed by the Identity Manager 10 and provide the authentication system 1 with a login identifier and password. Additionally, a user can register with the authentication system 1 using the voice interface.

The data interface can be a web porthole or another data network interface. The data interface also includes an input section such as a keyboard, a mouse, a graphical user interface or a touch screen. The data interface can be accessed using a mobile communication device, such as a cellular telephone or a smartphone, PDA, desktop computer or a laptop or the like. Similar to the voice interface, the user can register with the authentication system 1 using the data interface, and provide the authentication system 1 with a login identifier and password. The user can also enter an answer to the question posed by the Identity Manager 10 using the data interface. The biometric interface is used by the user as an added security device. The user inputs biometric information into the biometric interface. The biometric interface can be, but is not limited to, a fingerprint scanner and a retinal scanner.

Advertisement Opportunity Detector 20 detects an opportunity for a placement of a vendor related question, e.g., a targeted advertisement. The Advertisement Opportunity Detector 20 uses the user's commercial activity from the User Commercial Activity Databases 55 and the available advertisers from the Advertiser Database 60 to determine an opportunity to add a targeted advertisement to the set of candidate questions for the user. For example, the Advertisement Opportunity Detector 20 determines that the user flew on ABC, XYZ and CCC airlines and that ABC and CCC airlines are willing to pay for a placement. Therefore, the Advertisement Opportunity Detector 20 indicates to the Advertisement Selector 30 that there is an opportunity for a targeted advertisement for ABC and CCC. If there is no advertiser listed in the Advertiser Database 60 that correspond to any of a user's commercial activity from the user commercial activity database 55, the Advertisement Opportunity Detector 20 notes that a targeted advertisement opportunity was missed and records the missed opportunity in the Lost Opportunity Database 70 for each type of commercial activity. The Advertisement Opportunity Detector 20 can be a processor programmed with instructions to execute the functionality described herein. As such, the Advertisement Opportunity Detector 20 includes a storage device (not shown). The storage device contains a program.

The Advertisement Selector 30 selects a question from a plurality of candidate questions based on a set of criteria. The criteria includes the probability or score that is associated with the question, whether the question has be already answered by the user, the number of potential advertisers for a given type of commercial activity, the ability to add a targeted advertisement to the question, an amount a vendor/advertiser is willing to pay for the placement.

For example, the question can be selected to both maximize the score and maximize the payment amount. Each of the selection criteria is prioritized based upon a ranking. The ranking can be customized to a specific authentication system 1. For the exemplary authentication system 1 described herein, the probability or score that is associated with the candidate question has the highest ranking. The Advertisement Selector 30 can be a processor programmed with instructions to execute the functionality described herein. As such, the Advertisement Selector 30 includes a storage device (not shown). The storage device contains a program. Once a candidate question is selected, the Advertisement Selector 30 can add the targeted advertisement into the question by rewording the question. Alternatively, the Advertisement Selector 30 can forward the selected candidate question and advertiser name to the Identity Manager 10 and the Identity Manager 10 can reword the question.

Furthermore, the Identity Manager 10 can initially select a question from the candidate questions using the fusion algorithm 15 based upon a second set of criteria. The second set of criteria is a sub-set of criteria described above. The second set of criteria does not account for the advertisers. Once the question is selected, the selected question can be forwarded to the Advertisement Opportunity Detector 20 and the Advertisement Selector 30. The Advertisement Opportunity Detector 20 determines if there is an advertiser(s) associated with the type of commercial activity referenced in the selected candidate question. The Advertisement Opportunity Detector 20 forwards any candidate question having a target advertisement opportunity to the Advertisement Selector 30. Additionally, the advertiser record and the relevant commercial activity can be forwarded to the Advertisement Selector 30. If there is more than one advertiser, the Advertisement Selector 30 selects the specific advertisement using an amount the advertiser is willing to pay and whether the advertiser has already been presented to the user.

If there are no advertisers associated with the commercial activity in the candidate question, the Advertisement Opportunity Detector 20 notes that a targeted advertisement opportunity was missed and records the missed opportunity in the Lost Opportunity Database 70 for the commercial activity and can request a new question from the Identity Manager 10. Alternatively, the selected question can be posed to the user without attempting to replace the question.

The Accounting Processor 35 maintains the Accounting Database 65. The Accounting Processor 35 periodically generates an invoice to each advertiser for the targeted advertisements added to the authentication questions. The Accounting Processor 35 generates a running total of the number of targeted advertisements added to the authentication questions for each advertiser and charges the corresponding advertiser the appropriate agreed upon rate. The Advertisement Selector 30 outputs the advertiser name to the Accounting Processor 35 when a targeted advertisement is added to an authentication question.

The Accounting Processor 35 includes a storage device (not shown). The storage device contains a program of instructions for causing the Accounting Processor 35 to execute the functionality described herein. The storage device can be ROM. The Accounting Processor can be a CPU.

The Communication Activity Acquisition Unit 75 acquires user commercial activity from available sources. The user commercial activity can be manually input from the user during the registration process. Additionally, the Communication Activity Acquisition Unit 75 can automatically acquire the commercial activity. When the user registers with the authentication system 1, the users give permission for the authentication system 1 to access their commercial activity information. The commercial activity information can be retrieved from credit card statements, bank statements, brokerage account statements, customer studies or surveys and other public databases. The Communication Activity Acquisition Unit 75 automatically obtains the commercial information using one or more interfaces with the commercial data sources.

The Identity Manager 10, Advertisement Opportunity Detector 20, Advertisement Selector 30, the Accounting Processor 35, and Commercial Activity Acquisition Unit 75 have been separately described, however, they can be integrated in one device, such as a CPU, FPGA, and ASIC.

The Registered User Database 45 includes user specific information. The user specific information includes all personal information entered during the registration process. Additionally, the user specific information includes biometric data templates specific to a registered user input via the biometric interface. The user specific information also includes a user identifier and password. The user specific information is stored as a data record. The data record is indexed by a unique identifier. The Identity Manager 10 accesses the Registered User Database 45 when authenticating a user. Additionally, the Registered User Database 45 can include a list of user specific question candidates generate based upon the user commercial activity stored in the User Commercial Activity Database 55 and the available questions from the Question Template Database 50. Each candidate question includes the question and a score or probability. The score or probability is determined by the Fusion Algorithm 15 in the Identity Manager 10.

The Question Template Database 50 includes a sample question formatted. For example, the Question Template Database 50 can have the following question formats:

When you flew last on an (insert airline) airplane, where did you (insert location) go?
1. Have you visited (insert name) store in the last (insert time period)?
2. Was your last credit card invoice (Visa, Amex, etc.) over a certain (insert amount) amount?
3. What is the name of the street where the high school is located?
4. Did you go to a (insert location) (e.g., baseball game, sporting event, concert, etc) in the last (insert time period) month?

The User Commercial Activity Database 55 includes a list of user commercial activity that is either manually obtained during registration or automatically obtained by the Commercial Activity Acquisition Unit 75. Each item or entry in the list is an activity record. The list is sorted by activity type. For example, an activity type can be, flights, eating out (restaurants), hotel visits, sporting events, concerts, shopping etc. Within each type, the activity can be stored by date or amount. Each activity record includes, but is not limited to, the type of activity, the date of performance, the amount spent and the name of the vendor. This information is available from various different sources including public sources. The record is indexed by the vendor name.

The Advertiser Database 60 includes a list of vendors/advertisers that have subscribed with the authentication system 1. Each item or entry in the list is an advertiser record. Each advertiser record in the Advertiser Database 60 includes the vendor name, activity type and the agreed upon rate for the placement of the targeted add. Optionally, the record can include a specific name which the vendor wants mentioned in the question posed to the user. The Advertiser Database 60 can include the actual agreement between the advertiser and the authentication system 1. The Accounting Processor 35 accesses the agreed upon rate for the advertiser in the Advertiser Database 60 when calculating an appropriate rate to charge for the placement of the targeted advertisement.

The Accounting Database 65 includes a running total of the amount each advertiser is charged for a given pay period. This total is reset when an invoice is generated by the Accounting Processor 35. The Accounting Processor 35 updates the running total for the appropriate advertiser when a targeted advertisement is included in a question posed to the user by accessing the corresponding record in the Accounting Database 65. Each record includes the advertiser name, the running total, a start date, the invoice period, and the termination date for the current period. The Accounting Database 65 can include historical invoices for the advertiser. Further, the Identity Manager 10 accesses the Accounting Database 65 to determine if a specific question has been previously posed to the user to select an appropriate question without repeating the same question.

The Lost Opportunity Database 70 includes a list of missed advertisement opportunities. The list is generated by the Advertisement Opportunity Detector 20 based upon the user commercial activity and available advertisers. Each record in the list includes the type of activity, the number of times the opportunity is missed for the type of activity and the last missed opportunity date. Each time the same type of activity is missed, the number of times is incremented by one. The record keeps a running total of the missed opportunity. The authentication system 1 uses this list to evaluate new potential advertisers to the system. If a specific activity is listed in the list, the authentication system 1 will contact vendors corresponding to the commercial activity to have them subscribe to the authentication system, i.e., register to place a targeted advertisement.

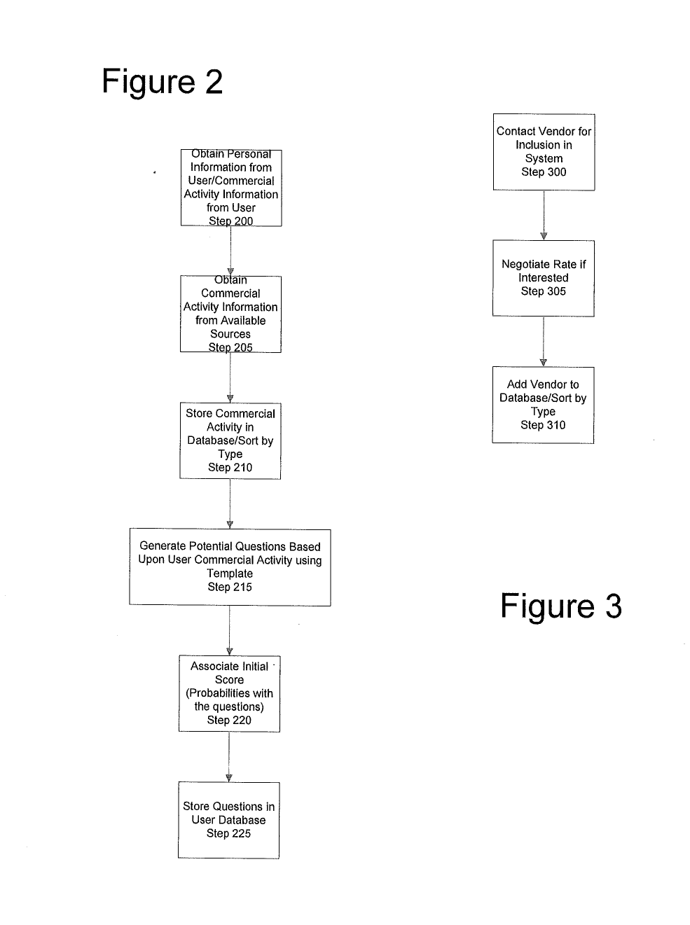

FIG. 2 illustrates a flow chart for an exemplary method for registering a user and an initially generating candidate questions for a user in accordance with the invention. When a user wants to register for a protected service or system, the user registers through the authentication system 1. The authentication system 1 requires personal information from the user to register with the system. At step 200, the authentication system 1 obtains the personal information from the user. The personal information includes the name, residential address, phone number, age, etc. The user is also asked to set up a user identifier and password. The personal information, user identifier and password are stored in the Registered User Database 45. Optionally, the user can input biometric information using the biometric input. The biometric information is subsequently used during an authentication. Additionally, the authentication system 1 can obtain user commercial activity information, which is manually inputted via the user. This commercial activity information is stored in the User Commercial Activity Database 55. The user also gives the authentication system approval or permission to obtain the user commercial activity from other sources. At step 205, the Commercial Activity Acquisition Unit 75 obtains the commercial activity for the user from at least one other source. For example, the Commercial Activity Acquisition Unit 75 accesses the user's credit card and debit card statements. The Commercial Activity Acquisition Unit 75 parses the statements and populates the User Commercial Activity Database 55 with the commercial activity information at step 210. The commercial activity information is sorted by type prior to storage in the User Commercial Activity Database 55. Steps 200-210 define the registration process.

At step 215, candidate questions are created based upon the user commercial activity stored in the User Commercial Database. The Identity Manager 10 uses the Fusion Algorithm 15 to select a sub-set of the questions from the Question Template Database 50 that are relevant to the user based on the commercial activity. For example, if the user travelled to a destination by airline within a period of time, all template questions related to travelling can be candidate questions. Alternatively, only questions related to travelling via airplane can be a candidate question.

At step 220, each selected candidate question is evaluated for a score or a knowledge probability. The Identity Manager 10 uses the Fusion Algorithm 15 to assign a score to the selected candidate(s). The assignment of a score or knowledge probability is well known in the art and therefore will not be described in detail. Once each selected candidate question is assigned a score or a knowledge probability, the candidate questions for a specific user is stored in the user record in the Registered User Database at step 225.

FIG. 3 an exemplary method for obtaining participating vendors and advertisers in accordance with the invention. In order to generate advertisement revenue, the authentication system 1 creates relationships between vendors and advertisers by contacting potential advertisers at step 300. A system operator informs the advertiser of an opportunity for a targeted advertisement. The advertisement is targeted because it is only displayed to a user that has already expressed interest in the goods and services as evidenced by the user's commercial activity history. Initially, the operator attempts to contact at least one vendor for each potential type of commercial activity which is related to a question in the Question Template Database 50. At step 305, if a vendor expresses interest in having its advertisement placed or added into a question posed to the user, a use rate is negotiated. The rate can be a “per-use” rate where the advertiser pays a set amount per each use. Additionally, the rate can be a flat rate for a specified period. Alternatively, a reverse auction can be used if more than one vendor is interested for a specific type of commercial activity, e.g., multiple airlines. Once the rate is determined, an advertiser record is created in the Advertiser Database 60 for the vendor and it is populated with the vendors name and agreed rate at step 310. The record is maintained with other advertiser records having the same type of commercial activity for easy search, e.g., sorted by type.

Steps 300-310 are performed initially when the authentication system 1 is configured. Additionally, steps 300-310 are performed whenever a new user registers with the authentication system 1 and the user's commercial activity is obtained, either manually during registration or automatically via the Commercial Activity Acquisition Unit 75 if there are any types of user activity discovered that do not have at least one advertiser associated with the commercial activity stored in the Advertiser Database 60.

Additionally, a system operator monitors the Lost Opportunity Database 70. When there is an entry in the Lost Opportunity Database 70, the system operator determines the type of activity and number of missed opportunities. Based upon this determination, the system operator will attempt to contact vendors corresponding to the missing type of commercial activity for inclusion. Additionally, if there is an entry in the Lost Opportunity Database 70, the authentication system 1 can automatically generate an indication to the system operator to alert the operator of a missed opportunity. This would reduce the lag time to respond to a missed or lost opportunity.

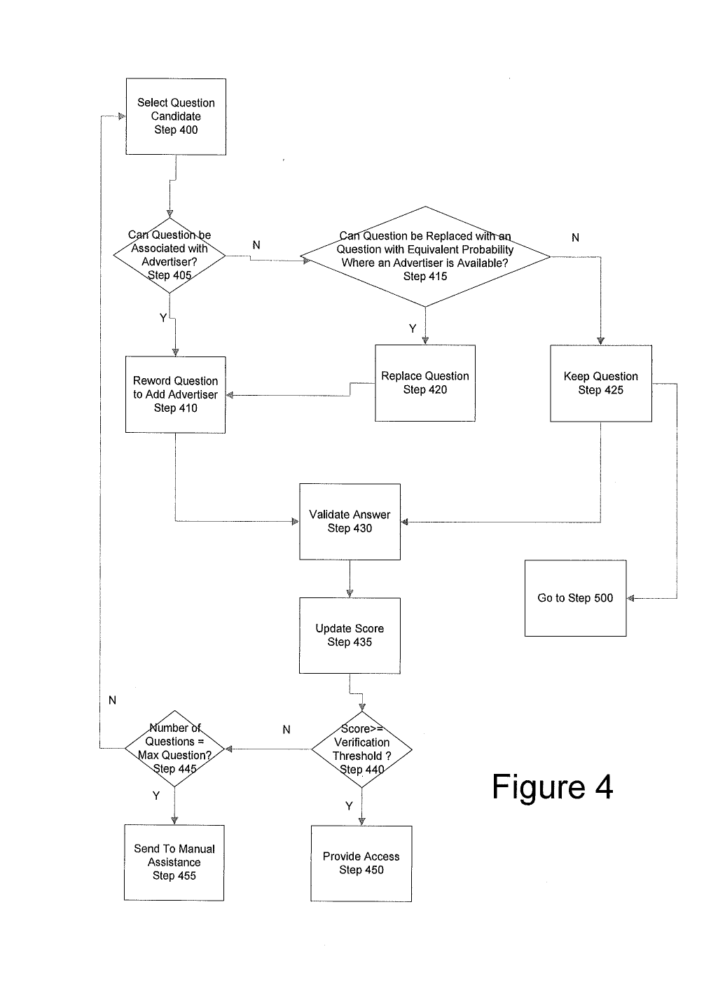

FIG. 4 illustrates a flow chart for an exemplary method for authenticating a register user in accordance with the invention. At step 400, the Identity Manager 10 selects question from the candidate questions stored in the Registered User Database 45. The selection is based at least on a score or probability assigned to each question. The goal is to select a question to maximum the score.

The selected question is forwarded to the Advertisement Opportunity Detector 20. At step 405, the Advertisement Opportunity Detector 20 determines if the question can be associated with an advertiser. The Advertisement Opportunity Detector 20 examines the selected question to determine the type of commercial activity. Then the Advertisement Opportunity Detector 20 searches the User Commercial Activity Database 55 for all commercial activity corresponding to the determined type. The Advertisement Opportunity Detector 20 uses the commercial activity records to determine the associated vendors. Additionally, the Advertisement Opportunity Detector 20 retrieves all advertiser records from the Advertiser Database corresponding to the determined type of commercial activity. If there is a match between at least one advertiser from the Advertiser Database 60 and the venders in the user commercial activity from the User Commercial Activity Database 55, then the question can be associated with an advertiser. If there is a match (“Y” at decision step 405), the selected question, a list of matching vendors and the user commercial activity is forwarded to the Advertisement Selector 30 at step 410. The Advertisement Selector 30 determines one advertiser from the list of matching vendors based upon the criteria described above. For example, if the question is “what is the amount of your last airfare on an airline,” the airline can be replaced with “Continental”. Additionally, the question can be reworded. For example, the question may also be modified from “what is the amount of the last airplane ticket purchase” to “did you buy Continental ticket on a given date? Not all questions can be parameterized with an advertiser reference. For example, the question “what is the name of the street where the high school is located,” cannot be parameterized.

If the selected question cannot be associated with an advertiser (for wherever reason), (“N” at decision step 405), the Advertisement Detector 20 notifies the Identity Manager 10. At step 415, the Identity Manager 10 determines if the previously selected question can be replaced with another question. The Identity Manager 10 determines if another question is assigned an equivalent score or probability. If there is another question, the question is forwarded to the Advertisement Opportunity Detector 20. The above-described process for the first selected question is repeated for the new question. If the question can be parameterized and if at least one advertiser from the Advertiser Database 60 and the venders in the user commercial activity from the User Commercial Activity Database 55 match, then the question can be associated with an advertiser (“Y” at decision step 415). The first question is then replaced with the new question at step 420. Afterwards, the new question is forwarded to the Advertisement Selector 30 at step 410 along with the list of matching advertisers and the relevant commercial activity. The Advertisement Selector 30 determines one advertiser from the list of matching vendors based upon the criteria described above.

If, however, the new selected question once again cannot be associated with an advertiser, the above process is repeated for each candidate question having an equivalent score or probability until the question can be associated with an advertiser. Alternatively, the above process can be only repeated for a preset number of times, e.g., a preset number of candidates that can be evaluated. The number of times can be set to reduce the delay in the authentication process, e.g., the time it takes to select each question. The authentication system 1 would include a counter. Each time a candidate is selected, the counter is incremented by 1. Prior to the selection of a new candidate, the value of the counter is compared with the preset number of times. Once the value of the counter equals the preset number of times, the question is posed to the user without a targeted advertisement. If no candidate question having an equivalent score or probability can be associated with an advertiser (“N” at step 415), the first selected question is used at step 425. Alternatively, the latest selected question can be used.

The question is posed to the user (either the question having the targeted advertisement or the first selected question). The user answers the question using the User Interface 5. At step 430, the Identity Manager 10 uses the Fusion Algorithm 15 to validate the answer. If the answer is correct, the value of the score assigned to the question is added to any existing score at step 435. If this question is the first question posed to the user, the total score =the score of the question. If the answer is incorrect, the score is not updated and the user is notified of an incorrect answer (not shown in FIG. 4). At step 440, the updated score is compared with a predetermined verification threshold. The predetermined verification threshold can be customized for a given authentication system 1. If the score is greater than or equal to the predetermined verification threshold (“Y” at decision step 440), the registered user is authenticated and allowed to access the secured system or the secured information. If the score is less than the predetermined verification threshold (“N” at decision step 440), the Identity Manager 10 determines if a maximum number of questions has been reached. The maximum number of questions is predetermined and can be customized for an authentication system 1. Each time a question is posed to a user, a counter is incremented by 1. The value of the counter is compared with the maximum number of questions. If the maximum number of questions is reached (“Y” at decision step 445), the user is sent to an operator for manual assistance at step 455. This would occur if a user answers a certain number of questions incorrectly. If the maximum number of questions is not reached (“N” at decision step 445), the proceed returns to step 400 and a new question is selected to maximum the score or probability. The process is repeated until the verification threshold is reached or the maximum number of questions is reached.

In parallel with posing the first question to the user after step 425, the process moves to step 500 to determine the reason why the questions having the equivalent score could not be associated with an advertiser. Additionally, any time a candidate question cannot be associated with an advertiser, the process can move to step 500 in parallel to determine the reason.

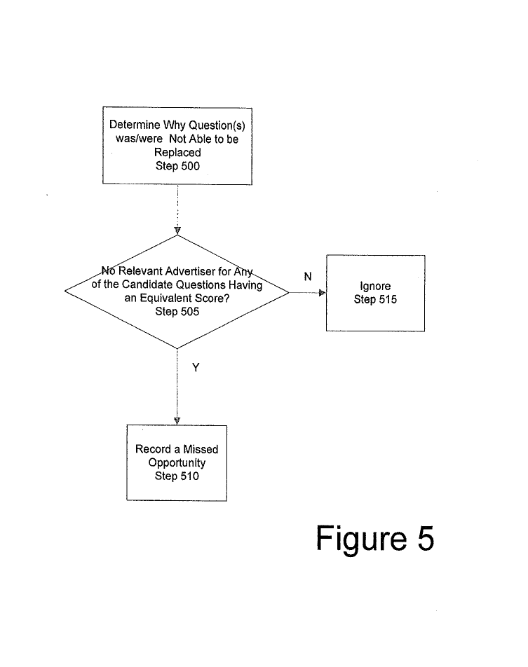

FIG. 5 illustrates a flow chart for an exemplary method for determining a missed opportunity to place a targeted advertisement. At step 500, the Advertisement Opportunity Detector 20 determines why a targeted advertisement was not able to be embedded into a selected question (or an equivalent scored question). As described above, some questions may not be able to be parameterized with an advertiser. For those questions, a targeted advertisement is not missed because the authentication system 1 does not have a stored advertiser for the type of commercial activity. The Lost Opportunity Database 70 is used for business development and therefore, only includes missed opportunities where a relevant stored advertiser is not included in the Advertiser Database 60. At step 505, the Advertisement Opportunity Detector 20 determines if the reason for not being able to associate an advertiser with the question is that there is no advertiser stored in the Adviser Database 60 for the type of commercial activity and which also corresponds with the user's commercial activity. If there was no advertiser (“Y” at decision step 505), the Advertisement Opportunity Detector 20 records an entry in the Lost Opportunity Database 70. If not (“N” at decision step 505), the opportunity was not missed and no missed opportunity to recorded. The evaluation described in FIG. 5 is performed for each question that could not be associated with a relevant advertiser.

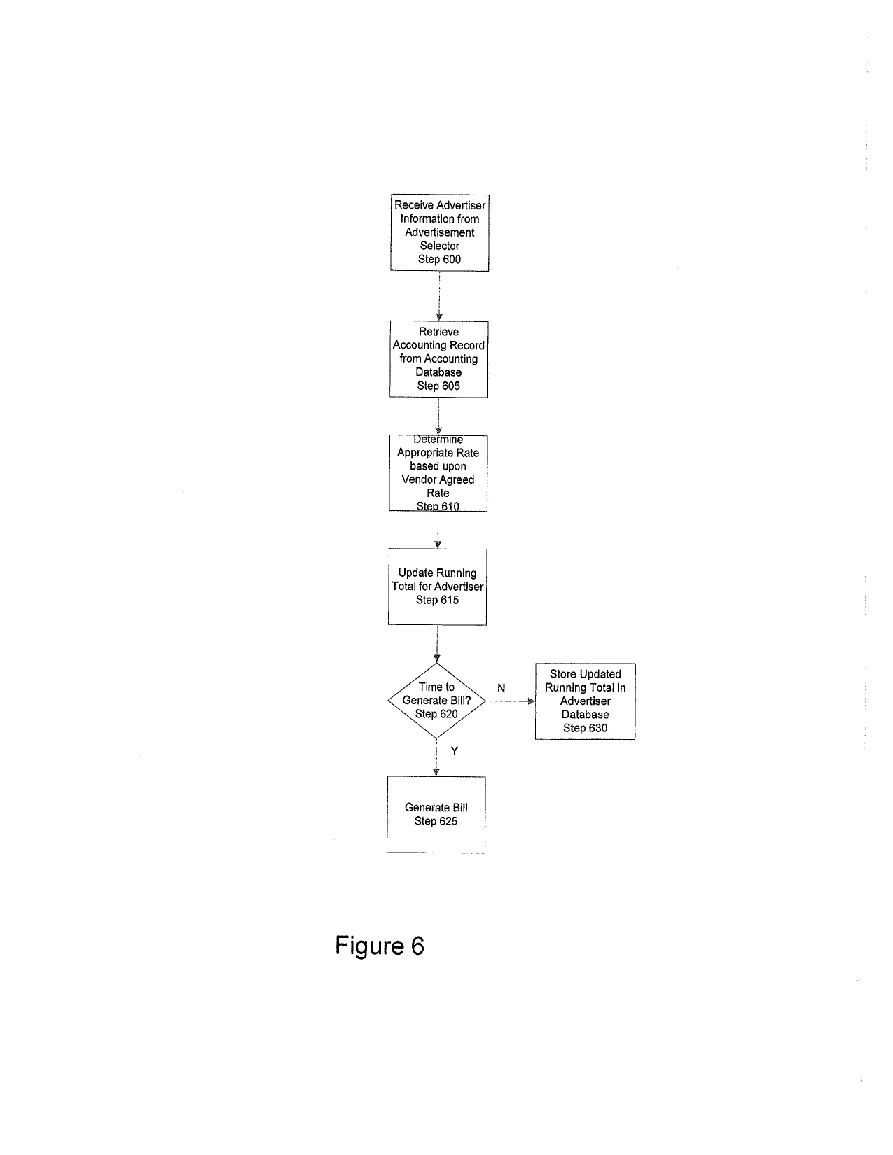

FIG. 6 illustrates a flow chart for an exemplary method for generating an invoice for an advertiser in accordance with the invention. At step 600, the Accounting Processor 35 received the advertiser information including the targeted advertisement from the Advertisement Selector 30 and/or Identity Manager 10. At step 605, the Accounting Processor 35 retrieves the accounting record corresponding to the received adviser information from the Accounting Database 65 and the advertiser record from the Advertiser Databases 60. The accounting record is indexes by the advertiser name. At step 610, the Accounting Processor 35 determines the appropriate rate to charge the advertiser using the agreed upon rate from the advertiser record. The Accounting Processor 35 maintains a running total for each advertiser. At step 615, the Accounting Processor 35 adds the determined appropriate rate to any existing running total in the accounting record. At step 620, the Accounting Processor 35 determines if the invoice period has ended based on the termination date in the accounting record. If the invoice period ended (“Y” at decision step 620), the Accounting Processor 35 generates an invoice at step 625. Additionally, the running total is stored in the accounting record in the Accounting Database 65. If the invoice period has not ended (“N” at decision step 620), the running total is stored in the accounting record in the Accounting Database 65 without generating an invoice.

As will be appreciated by one skilled in the art, the present invention may be embodied as a system, device(s), method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “Detector”, “Selector”, “Processor”, “Manager”, “Unit” or “system”.

Various aspects of the present invention may be embodied as a program, software, or computer instructions embodied or stored in a computer or machine usable or readable medium, which causes the computer or machine to perform the steps of the method when executed on the computer, processor, and/or machine. A computer readable medium, tangibly embodying a program of instructions executable by the machine to perform various functionalities and methods described in the present invention is also provided.

The devices, such as, the Detector, Selector, Processor, Unit and Manager, the system, the methods and the programs of the present invention may be implemented and run on a general-purpose computer or special-purpose computer system. The computer system may be any type of known or will be known systems such as, but not limited to, a virtual computer system and may typically include a processor, memory device, a storage device, input/output devices, internal buses, and/or a communications interface for communicating with other computer systems in conjunction with communication hardware and software, etc.

The computer readable medium could be a computer readable storage medium or a computer readable signal medium. Regarding a computer readable storage medium, it may be, for example, a magnetic, optical, electronic, electromagnetic, infrared, or semiconductor system, apparatus, or device, or any suitable combination of the foregoing; however, the computer readable storage medium is not limited to these examples. Additional particular examples of the computer readable storage medium can include: a portable computer diskette, a hard disk, a magnetic storage device, a portable compact disc read-only memory (CD-ROM), a random access memory (RAM), a read-only memory (ROM), an erasable programmable read-only memory (EPROM or Flash memory), an electrical connection having one or more wires, an optical fiber, an optical storage device, or any appropriate combination of the foregoing; however, the computer readable storage medium is also not limited to these examples. Any tangible medium that can contain, or store a program for use by or in connection with an instruction execution system, apparatus, or device could be a computer readable storage medium.

The terms “devices”, Detector“, “Selector”, “Processor”, “Unit”, “Manager” or “system”, “Databases”, “server” and “network” as may be used in the present invention may include a variety of combinations of fixed and/or portable computer hardware, software, peripherals, and storage devices. The system may include a plurality of individual components that are networked or otherwise linked to perform collaboratively, or may include one or more stand-alone components. The hardware and software components of the computer system of the present application may include and may be included within fixed and portable devices such as desktop, laptop, and/or server, and network of servers (cloud).

The above description provides illustrative examples and it should not be construed that the present invention is limited to these particular example. Thus, various changes and modifications may be effected by one skilled in the art without departing from the spirit or scope of the invention as defined in the appended claims.

What is claimed is:

1. A method for determining a question posed to a user during a user authentication process comprising:
obtaining user commercial activity, the user commercial activity being user purchases of goods and services from corresponding vendors, respectively;
storing the user commercial activity by activity type;
detecting a vendor placement opportunity by analyzing the user commercial activity;
determining if a vendor is registered for placement into a question based upon the detecting;
selecting a question based at least upon the detecting and determining for inclusion in a user authentication process; and
adding a vendor name into the selected question based upon a preset addition criterion.

2. The method for determining a question posed to a user during a user authentication process according to claim 1, further comprising:
recording the adding of the vendor name in a vendor record;
counting a number of times the vendor name is added into a question; and
generating an invoice for a vendor based upon the counted number of times.

3. The method for determining a question posed to a user during a user authentication process according to claim 1, wherein if there is no vendor registered for placement into a question, the method further comprising:
recording an indication of a missed opportunity for the activity type.

4. The method for determining a question posed to a user during a user authentication process according to claim 3, further comprising:
generating, periodically a notification containing all recorded indications of a missed opportunity, by activity type.

5. The method for determining a question posed to a user during a user authentication process according to claim 1, further comprising
registering vendors for placement into a question, the registering creates a vendor record, the vendor record including at least a vendor name, an activity type and a payment amount, wherein the determining if a vender is registered comprises examining a vendor record.

6. The method for determining a question posed to a user during a user authentication process according to claim 5, wherein the payment amount is per placement.

7. The method for determining a question posed to a user during a user authentication process according to claim 1, wherein the question is selected from a plurality of prestored questions.

8. A method for determining a question posed to a user during a user authentication process comprising:
obtaining user commercial activity, the user commercial activity being user purchases of goods and services from corresponding vendors, respectively;
storing the user commercial activity by activity type;
generating a set of candidate questions for a user based upon the user commercial activity, each candidate question in the set of candidate questions is associated with a score;
selecting one candidate question from the set of the candidate questions based upon a first selection criteria;
detecting a vendor placement opportunity in the selected candidate question by analyzing the user commercial activity; and
adding a vendor name into the selected candidate question based upon the detecting.

9. The method for determining a question posed to a user during a user authentication process according to claim 8, wherein the detecting further comprises:
determining a type of commercial activity; and
determining if at least one vendor is registered for placement into a question for the type of commercial activity associated with the selected candidate question and for the user commercial activity.

10. The method for determining a question posed to a user during a user authentication process according to claim 9, wherein if there are more than one vender register for placement into a question for the type of commercial activity associated with the selected candidate question and for the user commercial activity, the method further comprises:
selecting one vendor from the more than one vendor based upon a second selection criteria.

11. The method for determining a question posed to a user during a user authentication process according to claim 10, wherein the second selection criteria is an amount of money each vendor is willing to pay.

12. The method for determining a question posed to a user during a user authentication process according to claim 8, wherein if there is no vendor placement opportunity for the selected candidate question, the method further comprises:
determining if the selected candidate question can be replaced with another candidate question from the set of candidate questions having an equivalent score as the selected candidate question,
wherein if the selected candidate question can be replace, the method further comprises:
detecting a vendor placement opportunity in the another candidate question by analyzing the user commercial activity,
wherein if there is a vendor placement opportunity in the another candidate question, a vendor name is added to the another candidate question.

13. The method for determining a question posed to a user during a user authentication process according to claim 12, wherein if there is no other candidate questions that can replace the selected candidate question, the selected candidate question is posed to the user.

14. The method for determining a question posed to a user during a user authentication process according to claim 8, wherein if there is no vendor placement opportunity for the selected candidate question, the method further comprises:
recording an indication of a missed opportunity for the activity type.

15. A computer readable storage medium having a computer program for causing a processor to execute a method for determining a question posed to a user during a user authentication process, the method comprising:
obtaining user commercial activity, the user commercial activity being user purchases of goods and services from corresponding vendors, respectively;
storing the user commercial activity by activity type;
generating a set of candidate questions for a user based upon the user commercial activity, each candidate question in the set of candidate questions is associated with a score;
selecting one candidate question from the set of the candidate questions based upon a first selection criteria;
detecting a vendor placement opportunity in the selected candidate question by analyzing the user commercial activity; and
adding a vendor name into the selected candidate question based upon the detecting.

16. The computer readable storage medium according to claim 15, wherein the detecting further comprises:
determining a type of commercial activity; and
determining if at least one vendor is registered for placement into a question for the type of commercial activity associated with the selected candidate question and for the user commercial activity.

17. The computer readable storage medium according to claim 16, wherein if there are more than one vender register for placement into a question for the type of commercial activity associated with the selected candidate question and for the user commercial activity, the method further comprises:
selecting one vendor from the more than one vendor based upon a second selection criteria.

18. The computer readable storage medium according to claim 15, wherein if there is no vendor placement opportunity for the selected candidate question, the method further comprises:
determining if the selected candidate question can be replaced with another candidate question from the set of candidate questions having an equivalent score as the selected candidate question,
wherein if the selected candidate question can be replace, the method further comprises:
detecting a vendor placement opportunity in the another candidate question by analyzing the user commercial activity,
wherein if there is a vendor placement opportunity in the another candidate question, a vendor name is added to the another candidate question.

19. The computer readable storage medium according to claim 15, wherein if there is no vendor placement opportunity for the selected candidate question, the method further comprises:
recording an indication of a missed opportunity for the activity type.

20. A system for determining a question posed to a user during a user authentication process comprising:
a storage device having processor readable instructions,
a processor configured to, when executing the processor readable instructions, provide:
an obtaining unit for obtaining user commercial activity, the user commercial activity being user purchases of goods and services from corresponding vendors, respectively;
a question generating unit for generating a set of candidate questions for a user based upon the user commercial activity, each candidate question in the set of candidate questions is associated with a score;
a selecting unit for selecting at least one candidate question from the set of candidate questions based at least upon the score;
a detecting unit for a vendor placement opportunity in the selected at least one candidate question by analyzing the user commercial activity and corresponding available advertisers; and
a question unit for adding a vendor name into a candidate question based upon the detecting.

21. The system for determining a question of claim 20, wherein the processor is further configured to, when executing the processor readable instructions, provide:
a lost opportunity detecting unit for detecting a lost advertisement opportunity when there is no corresponding available advertiser for the selected at least one candidate question and for recording the lost advertisement opportunity.
